(19) United States
(12) Patent Application Publication
(10) Pub. No.: US 2007/0214022 A1
(43) Pub. Date: Sep. 13, 2007

(54) Method and system for long term care insurance product

(75) Inventors: Ronald R. Hagelman JR., New Braunfels, TX (US); James W. Nash III, New Braunfels, TX (US); Barry J. Fisher, Bell Canyon, CA (US)

Correspondence Address: MCKEE, VOORHEES & SEASE, P.L.C., 801 GRAND AVENUE, SUITE 3200, DES MOINES, IA, 50309-2721, US

(73) Assignee: REPUBLIC MARKETING GROUP, INC., NEW BRAUNFELS, TX (US)

(21) Appl. No.: 11/374,243

(22) Filed: Mar. 13, 2006

(51) Int. Cl. G06Q 40/00

(52) U.S. Cl. 705/4

(57) ABSTRACT

A method includes providing a long-term care insurance product to an insured, determining a benefit pool associated with the long-term care insurance product, the benefit pool based on benefits available to the insured at a future point in time after issuance of the long-term care insurance product and calculated by number of days of benefit chosen multiplied by daily benefit chosen increased over time from issuance until the future point in time by an inflation protection factor, providing an accelerated benefit rider providing for making available the benefit pool associated with the insurance product upon issuance of the product to pay for claims for long-term care, and providing a return of premium rider wherein the return of premium rider provides for returning at least a portion of premiums paid by the insured upon election of the insured provided such election is made before occurrence of a future event.

### FIELD OF THE INVENTION

The present invention relates to insurance for long term care. More particularly, the present invention relates to acceleration benefit and return of premium riders.

### BACKGROUND OF THE INVENTION

Long term care is a significant and well-recognized problem. Generally, long-term care includes medical, personal, and/or social services needed to meet basic living requirements for an extended period of time. Long-term care is usually provided with a caregiver within the home or through a nursing home or an assisted living facility. According to one estimate of The National Association of Insurance Commissioners, there is a 41 percent chance that those over age 65 will spend an average of 2.5 years in a nursing home. Although Medicare may pay a benefit for a portion of a stay (i.e. 100 days), this projected average is far longer in length and is a significant financial burden.

Insurance products are designed to leverage a future random risk. Although the potential incidence of utilizing a long term care insurance product is fairly high, claims do not however normally occur until late in the product's ownership. Specifically, for example, nursing home populations are not statistically significant until the early to mid eighties. However, because the cost of ownership of the product increases with age as you near the proximity of the claim, it is very important to buy at younger ages.

Thus, at some level, people, particularly those in their 50s have recognized the need for appropriate insurance to provide benefits in the event of the need for long term care. Ideally, customers would like to obtain insurance policies for long term care that have lifetime benefits or unlimited benefits. Such a policy would mean that they do not have to worry about their coverage ending before their illness does. The problem with such an insurance product is that pricing on unlimited benefits has made long-term care insurance affordable only to the very affluent. Therefore, because of the expense of long term care insurance, most customers need to compromise on their insurance and the way in which they do so is by electing insurance which limits the benefit period. The most common benefit period that customers buy is between three to five years. However, despite buying the insurance, the customers still remain exposed to catastrophically long risk as a tradeoff for cost savings.

Recognition of the risks that remain even with the purchase of a long-term care insurance policy, if such policy is less than one that provides lifetime benefits, many simply choose not to purchase long-term care insurance. They can not afford policies which provide lifetime benefits. They determine that long-term care insurance with less than lifetime benefits does not hold enough value in relation to cost.

With long-term care insurance, it is important for customers to buy before they experience significant changes in health which could increase the cost or prevent access entirely. Therefore the best time to buy is often in one's fifties when costs can be established at a lower level and medical underwriting is not a problem. The best scenario for long-term care ownership is for one to buy in their fifties with possible claims occurring in one's eighties. There is a significant gap in time then between when one should purchase a policy and when claims may occur. The greater the real and perceived distance to the claim, the more difficult it is to convince a consumer to buy in a timely manner. Thus there are difficulties in selling long-term care insurance to customers.

Another reason why customers may choose not to purchase a long-term care insurance policy is that they recognize that if they change their minds about their need for such a policy in the future, there is no mechanism for them to receive any money back for the premiums which they have paid. Where customers are already questioning the value of tong-term insurance with less than lifetime benefits and can not afford long-term care insurance with lifetime benefits, the inability to receive money back serves as an additional disincentive to buy such insurance. It is recognized that some prior art health care policies may provide non-forfeiture benefits. Such non-forfeiture benefits pay premiums back to a designee of the insured upon death of the insured minus any claims that have been made. Thus, some type of money back situation is achieved. Of course, in such a policy, although premiums are not lost if claims are not made, the insured receives no benefit from the premiums in their lifetime and there is no mechanism for the insured to receive any money back in their lifetime. Thus, the disincentive to purchasing such policies remains.

Another problem facing the long-term care insurance industry is that policies have become increasingly complex and it is often unclear to consumers, even sophisticated consumers, of the relationship between the price and the primary benefit of the policy. This problem is due in part to the inability of insurance companies to fully recognize and appreciate the problems of customers and customer objections to current long term health care policies and how to provide a policy that addresses these problems, overcomes these objections, and is still economically viable for the insurance companies. Thus, in attempts to increase their business, the long-term care insurance industry has attempted to adapt and adjust their offerings to accommodate customers. However, it is believed that these attempts have not dealt with the actual problems and objections, but have merely complicated product offerings to a point where customers are not aware of the problems and objections.

Therefore, what is needed is improved insurance product which recognizes and manages these problems.

### BRIEF SUMMARY OF THE INVENTION

Therefore, it is a primary object, feature, or advantage of the present invention to improve upon the availability of insurance for long term care.

A further object, feature, or advantage of the present invention is to make long term care insurance affordable.

Another object, feature, or advantage of the present invention is to make policies for long term care which are easily explainable to customers and potential customers and readily understandable by customers and potential customers.

It is a further object, feature, or advantage of the present invention to provide a policy for long term care which provides the insured with greater protection against a potential catastrophic early claim at a younger age.

Another object, feature, or advantage of the present invention is to provide a guaranteed renewable rider which can be added to a long term care policy which provides for either compound automatic benefit increase or simple automatic benefit increase.

Yet another object, feature, or advantage of the present invention is to provide a rider for a long term care policy which provides for return of premium.

Yet another object, feature, or advantage of the present invention is to provide a rider for a long term care policy which provides for a return of premium in a manner which benefits the customer during the lifetime of the customer.

A still further object, feature, or advantage of the present invention is to provide a long term care insurance policy which is attractive to customers as it has immediate benefit.

One or more of these and/or other objects, features, or advantages of the present invention will become apparent from the specification and claims that follow.

According to one aspect of the present invention, a method includes providing a long-term care insurance product having a benefit increase rider to an insured. The method further includes determining a benefit pool associated with the long-term care insurance product. The benefit pool is based on benefits available to the insured at a future point in time after issuance of the long-term care insurance product and calculated by number of days of benefit chosen multiplied by daily benefit chosen increased over time from issuance until the future point in time by an inflation protection factor. According to the method, the benefit pool associated with the insurance product is made available to the insured upon issuance of the product to pay for claims for long-term care. The inflation protection factor may be a simple increase over time or may be compounded over time. The point in time may be defined as a future age of the insured, such as age 85.

The long-term care insurance product may further include a return of premium rider. The return of premium rider provides for returning at least a portion of premiums paid by the insured upon election of the insured provided such election is made before occurrence of a future event. The future event may be the insured's attainment of a particular age, such as age 75. The return of premium rider further provides for increasing the benefit pool if the insured does not make the election. A computer system may be used to administer the product such as by maintaining an electronic record indicative of the benefit pool and claims paid from the benefit pool or other administrative information. The computer system may also provide outputs of these electronic records.

According to another aspect of the present invention, an insurance product including a benefit increase rider is provided. The insurance product includes an accelerated benefit rider and a return of premium rider. The accelerated benefit rider provides for determining a benefit pool associated with the insurance product, the benefit pool based on benefits available to the insured at a future point in time after issuance of the insurance product and calculated by number of days of benefit chosen multiplied by daily benefit chosen increased over time from issuance until the future point in time by an inflation protection factor, and providing an accelerated benefit rider providing for making available the benefit pool associated with the insurance product upon issuance of the product to pay for claims. The return of premium rider provides for returning at least a portion of premiums paid by the insured upon election of the insured, provided such election is made before occurrence of a future event. The insurance product may be administered by a computer. The insurance product may be illustrated by a policy illustration output from a computer.

### BRIEF DESCRIPTION OF THE DRAWINGS

FIG. 1 is a pictorial representation of an insurance policy of the present invention.

FIG. 2 is a block diagram illustrating one embodiment of a system for administering an insurance product of the present invention.

FIG. 3 is a flow diagram illustrating one embodiment of a methodology of the present invention.

FIG. 4 is a flow diagram illustrating another embodiment of a methodology of the present invention.

FIG. 5A-5D provide benefit illustrations according to exemplary embodiments of the present invention.

### DETAILED DESCRIPTION OF THE PREFERRED EMBODIMENT

The present invention provides for two types of riders to be used with a long-term care insurance policy. The first type of rider is a maximum lifetime benefit acceleration rider. The second type of rider is a return of premium rider. Each of these riders when used alone or together provide significant advantages to a long-term care insurance policy.

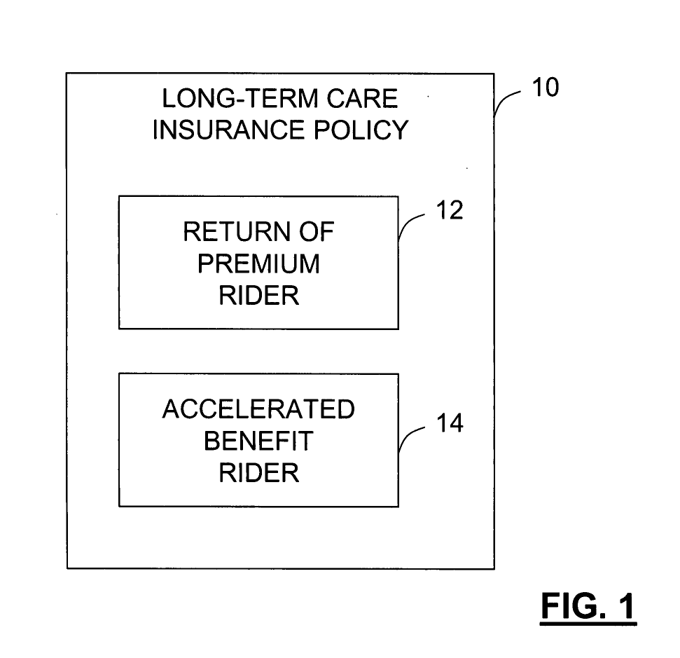

FIG. 1 provides a pictorial representation of one embodiment of an insurance product of the present invention. As shown in FIG. 1, a long-term care insurance policy 10 has an associated return of premium rider 12 and an associated accelerated benefit rider 14.

The accelerated benefit rider 14 provides a compromise for target buyers, such as those in their 50's by creating a benefit pool of money that would equal approximately 15-20 years of benefits in the event of a claim very soon after purchases, grading down to the three to five years of benefit pool by the time they reach the more typical claim age of 80-85. This is accomplished for a cost that is much closer to the cost of 3-5 year benefits only, than to the cost of lifetime benefits, thereby making the accelerated benefit rider affordable for the majority of customers that opt for 3-5 year benefits that is the most they can afford.

The accelerated benefit rider eliminates consumer concern about purchasing a long-term insurance product with less than lifetime benefits by providing an immediate benefit equal to the amount the policy would be worth at a set age, (such as 85), based on the inflation factor that they purchase the policy with at time of issue.

The accelerated benefit rider is preferably always sold in combination with policies that include either 5 percent simple or compound benefit increase riders. Therefore, as an example, the underlying policy benefit with 5 percent compound inflation grows from $100 per day at age 55 when issued to $412 per day at age 85. Therefore, a 5 year benefit policy has a benefit pool of $182,500 when issued at age 55. At age 85, the benefit pool equals $751,900. The accelerated benefit rider provides the additional dollars necessary to make the benefit pool that will be available at age 85 ($751,900) available from the beginning when issued at age 55, and maintaining the total benefit pool level at that amount until age 85. Essentially the rider dollars decrease as the underlying policy benefit increases due to the compound inflation rider. At age 85, the benefit from the rider has dissipated and the premium charged for the rider terminates.

The accelerated benefit rider differs from other insurance products as there is no other benefit like it available in the long-term care insurance industry. All limited benefit policies offered in the market today can only provide a benefit pool at issue equal to the daily benefit at issue times the length of the benefit period ($100 per day ×5 years, for $182,500 in the example). The policy of the present invention with the accelerated benefit rider, can provide much greater protection against that potential catastrophic early claim at the younger age (55), at a cost much closer to the regular limited benefit cost than to the lifetime benefit cost. It therefore provides a solution for a price sensitive segment of the market that would not otherwise be able to cover the early catastrophic claim portion of their total risk.

The rider immediately increases, at the time of issue, to the policy's maximum lifetime benefit amount to the amount that will be in effect at attained age (such as 85) according to the benefits increase rider. The rider need not affect the maximum daily benefit or any daily home and community-based care benefit if such benefits are included.

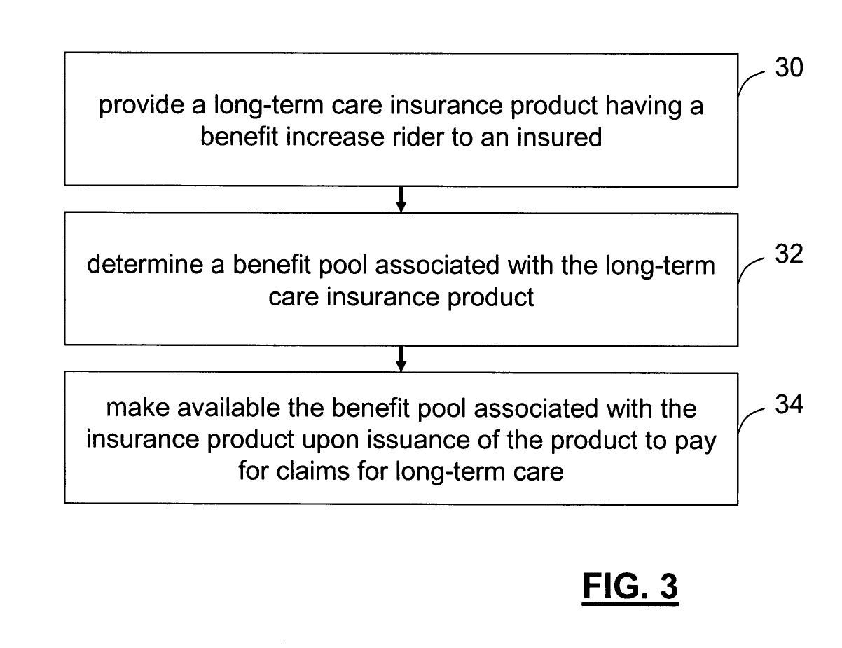

One methodology for providing the accelerated benefit rider 14 is shown in FIG. 3. As shown in FIG. 3, step 30 is to provide a long-term care insurance product having a benefit increase rider to an insured. Step 32 is to determine a benefit pool associated with the long-term care insurance product. Step 34 is to make available the benefit pool associated with the insurance product upon issuance of the product to pay for claims for long-term care.

Returning to FIG. 1, note that the insurance product 10 can include the return of premium rider or value rider 12. The return of premium rider 12 can potentially extend the benefit payment of the policy many years beyond the benefit period chosen depending on the client's age of issue and age of claim.

The rider pays a return of premium benefit upon termination of the policy for any reason before an attained age (such as 75). Such an age is selected to be less than the age where claims are usually encountered. The amount of the benefit returned is equal to a percentage of total premiums paid less the amount of any incurred claims paid or payable under the policy and other riders (excluding the return of premium rider) from the effective date to the date of termination. The below table provides one example of the manner in which the percentages of premium returned can be set.

| If termination occurs | Percentage |
|---|---|
| During the first 3 years | 0% |
| During the 4^{th} year | 40% |
| During the 5^{th} year | 50% |
| During the 6^{th} year | 60% |
| During the 7^{th} year | 70% |
| During the 8^{th} year | 80% |
| During the 9^{th} year | 90% |
| Between the start of the 10^{th} | 100% |
| year and age 75 | |
| During or after age 75 | 0% |

In addition, after age 75, total premiums paid since the effective date are added to the maximum lifetime benefit of the policy. Preferably once effective this rider cannot be terminated unless the policy is also terminated. It is important to appreciate that with this rider, the customer does not lose their premiums. Assuming, in this example, that they maintain the policy for 10 years they can receive their premium back. After age 75, the total premiums paid are added to the maximum lifetime benefit of the policy, so they are directly receiving benefit from subsequent premium payments.

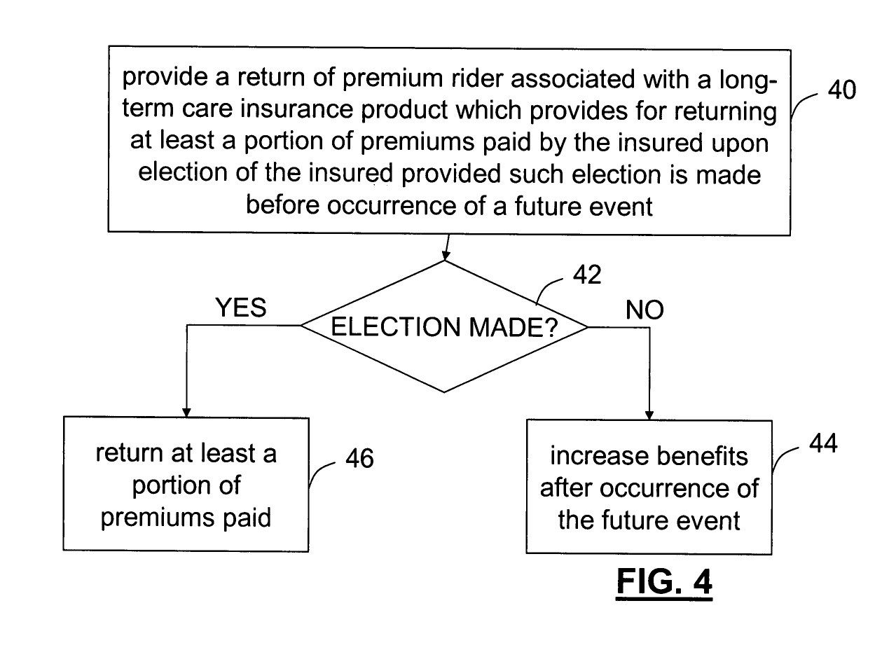

FIG. 4 illustrates one embodiment of a methodology for a return of premium rider 12. In FIG. 4, step 40, the methodology is to provide a return of premium rider associated with a long-term care insurance product which provides for returning at least a portion of premiums paid by the insured upon election of the insured provided such election is made before occurrence of a future event. Next in step 42, there the opportunity for an election to be made during the term of the policy but before the future event. If the election is made, then in step 46, at least a portion of the premiums are returned. If the election is not made, then in step 44, benefits are increased by additional premiums. It is preferred that the benefits are increased by increasing the number of days of benefits under the policy, however, the present invention contemplates that the benefits could be increased in other ways, such as by increasing the daily benefit.

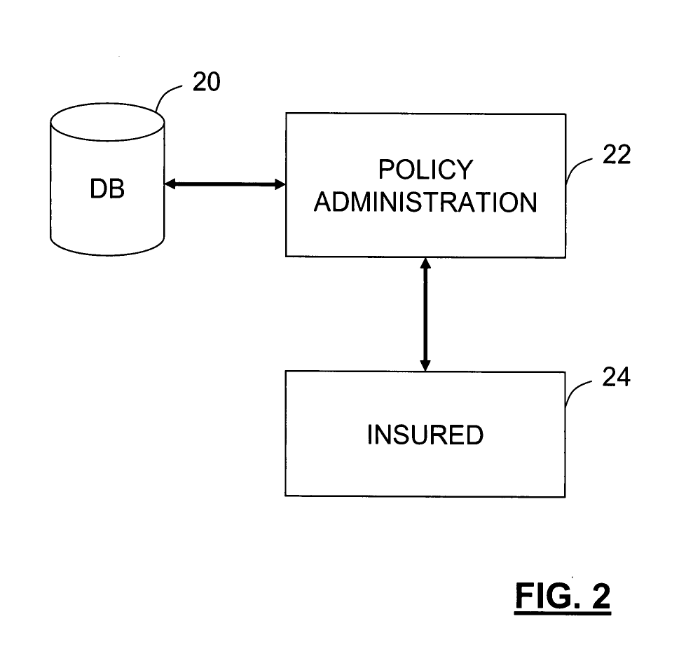

FIG. 2 illustrates one embodiment of a computer-implemented system of the present invention. In FIG. 2, a database 20 with policy information is operatively connected to a policy administration computer system 22. The policy administration computer system 22 is in operative communication with one or more of the insured 24. It is to be understood that policy information can include premium payment information, claim information, or other types of information associated with administering an insurance policy. It is to be further understood that the operative communication between the policy administration computer system 22 and the insured 24 need not be direct communication but can be through any number of intermediaries.

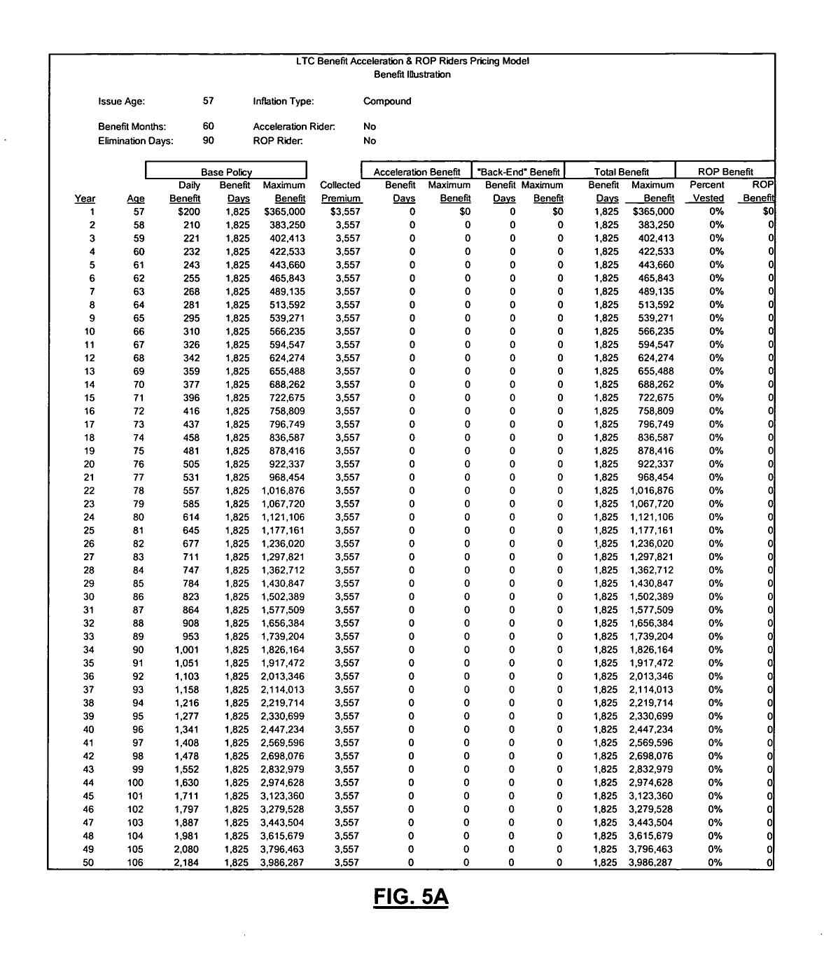

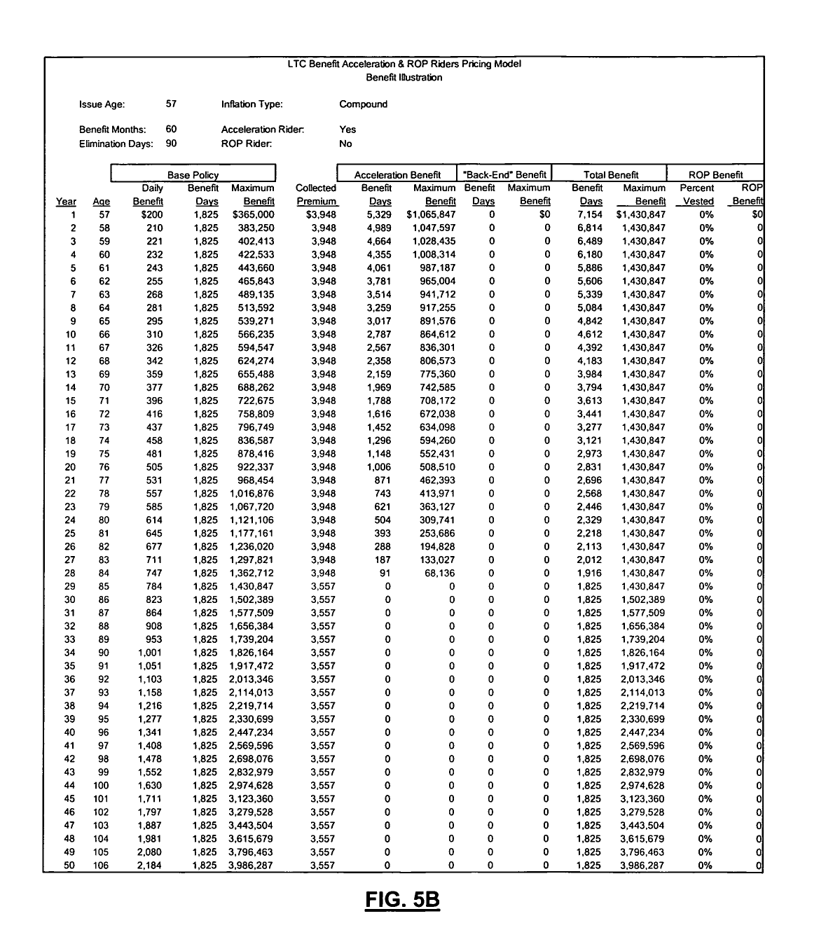

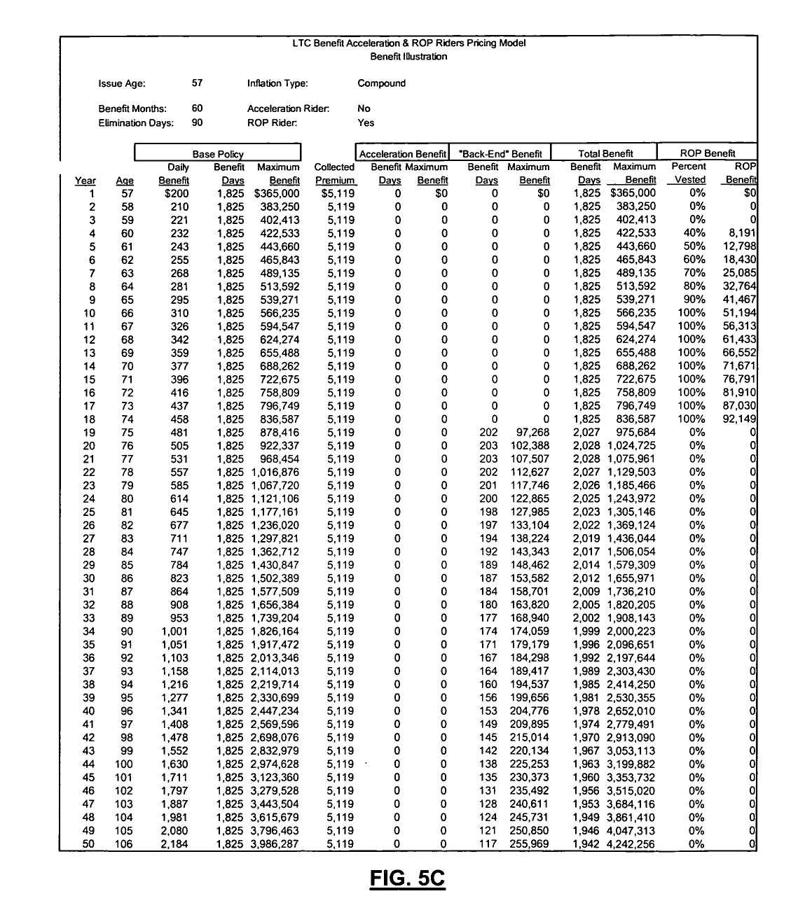

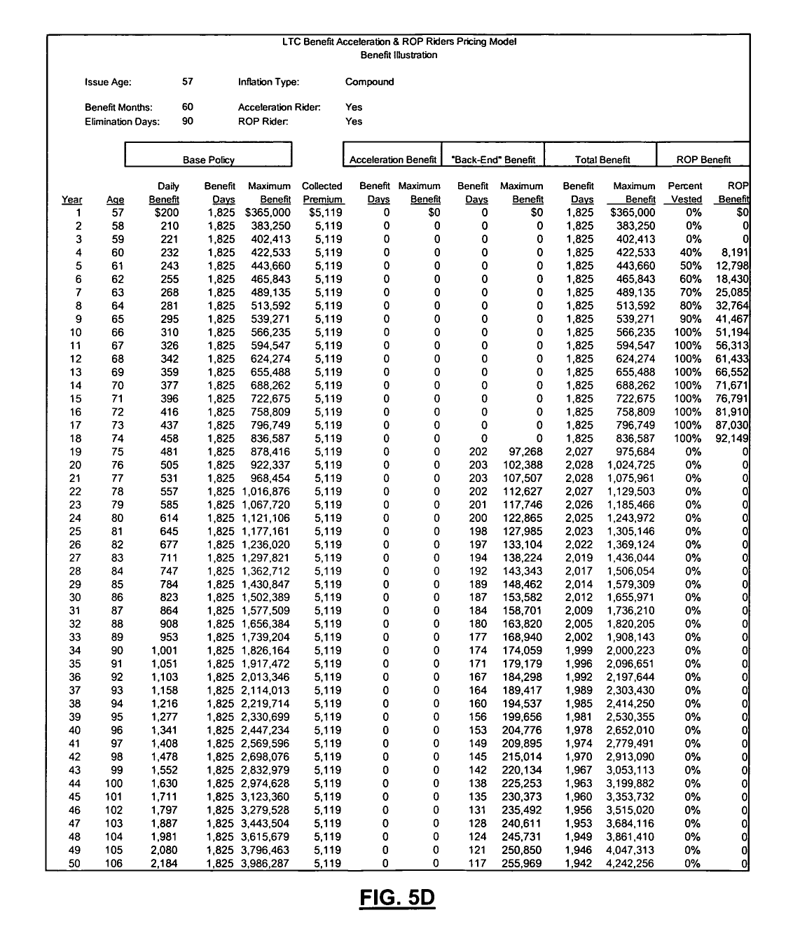

FIG. 5A-5D illustrate policy illustrations according to various embodiments of the present invention. FIG. 5A provides a policy illustration for a long term care policy without an acceleration rider or a return of premium rider. FIG. 5B provides a policy illustration for a long term care policy with an acceleration rider and with compound inflation. FIG. 5C provides a policy illustration for a long term care policy with a return of premium rider an no acceleration rider. FIG. 5D provides a policy illustration for a long term care policy with an acceleration rider and a return of premium rider and with compound inflation. That which is shown is merely exemplary and the present invention is not to be limited by these policy illustrations. It is to be further understood that these policy illustrations are created using the assistance of a computer.

Therefore, an insurance produce and a methods for providing an insurance product have been described. It is to be understood that the present invention is not to be limited to the specific description provided herein, as the present invention contemplates numerous variations within its spirit and scope. The present invention contemplates variations in the type of insurance product or policy, whether or not a benefit increase rider is provided (and if so, its type), and other variations all within the spirit and scope of the invention.

What is claimed is:

1. A method for a long-term care insurance product including a benefit increase rider, the method comprising:
providing a long-term care insurance product having a benefit increase rider to an insured;
determining a benefit pool associated with the long-term care insurance product, the benefit pool based on benefits available to the insured at a future point in time after issuance of the long-term care insurance product and calculated by number of days of benefit chosen multiplied by daily benefit chosen increased over time from issuance until the future point in time by an inflation protection factor;
making available the benefit pool associated with the insurance product upon issuance of the product to pay for claims for long-term care.

2. The method of claim 1 wherein the inflation protection factor is compounded over time.

3. The method of claim 1 wherein the inflation protection factor is a simple increase over time.

4. The method of claim 1 wherein the inflation protection factor is 5 percent compounded annually.

5. The method of claim 1 wherein the point in time is defined by the insured reaching age 85.

6. The method of claim 1 wherein the long-term care insurance product further comprises a return of premium rider wherein the return of premium rider provides for returning at least a portion of premiums paid by the insured upon election of the insured provided such election is made before occurrence of a future event.

7. The method of claim 6 wherein the future event is associated with the insured attaining 75 years of age.

8. The method of claim 6 wherein the return of premium rider further provides for increasing the benefit pool if the insured does not make the election.

9. The method of claim 1 further comprising maintaining an electronic record indicative of the benefit pool and claims paid from the benefit pool.

10. The method of claim 1 further comprising providing an output indicative of a remaining benefit pool, the remaining benefit pool being the benefit pool less claims paid from the benefit pool.

11. A method for a long-term care insurance product including a benefit increase rider, the method comprising:
providing a long-term care insurance product having a benefit increase rider to an insured;
determining a benefit pool associated with the long-term care insurance product, the benefit pool based on benefits available to the insured at a future point in time after issuance of the long-term care insurance product and calculated by number of days of benefit chosen multiplied by daily benefit chosen increased over time from issuance until the future point in time by an inflation protection factor;
providing an accelerated benefit rider providing for making available the benefit pool associated with the insurance product upon issuance of the product to pay for claims for long-term care; and
providing a return of premium rider wherein the return of premium rider provides for returning at least a portion of premiums paid by the insured upon election of the insured provided such election is made before occurrence of a future event.

12. The method of claim 11 wherein the inflation protection factor is compounded over time.

13. The method of claim 11 wherein the point in time is defined by the insured reaching age 85.

14. The method of claim 11 wherein the future event is associated with the insured attaining 75 years of age.

15. The method of claim 11 wherein if the election is not made, increasing the benefit pool by at least a portion of premiums paid after occurrence of the future event.

16. The method of claim 11 further comprising maintaining an electronic record indicative of the benefit pool and claims paid from the benefit pool.

17. The method of claim 11 further comprising providing an output indicative of a remaining benefit pool, the remaining benefit pool being the benefit pool less claims paid from the benefit pool.

18. An insurance product including a benefit increase rider, the insurance product comprising:
an accelerated benefit rider;
a return of premium rider;
wherein the accelerated benefit rider provides for:
(a) determining a benefit pool associated with the insurance product, the benefit pool based on benefits available to the insured at a future point in time after issuance of the insurance product and calculated by number of days of benefit chosen multiplied by daily benefit chosen increased over time from issuance until the future point in time by an inflation protection factor;
(b) providing an accelerated benefit rider providing for making available the benefit pool associated with the insurance product upon issuance of the product to pay for claims;
wherein the return of premium rider provides for returning at least a portion of premiums paid by the insured upon election of the insured, provided such election is made before occurrence of a future event.

19. The insurance product of claim 18 wherein the insurance product being illustrated by an output from a computer.
